(19) United States
(12) Patent Application Publication
(10) Pub. No.: US 2011/0098958 A1
(43) Pub. Date: Apr. 28, 2011

(54) AZIMUTH COMPUTING DEVICE, AZIMUTH COMPUTING METHOD, AZIMUTH COMPUTING PROGRAM, AND ELECTRONIC DEVICE

(76) Inventors: Kisei Hirobe, Miyagi-Ken (JP); Katsuyuki Kawarada, Miyagi-Ken (JP)

(21) Appl. No.: 12/982,039

(22) Filed: Dec. 30, 2010

Related U.S. Application Data
(63) Continuation of application No. PCT/JP2009/061492, filed on Jul. 8, 2009.

(30) Foreign Application Priority Data
Jul. 8, 2008 (JP) 2008-177525

(51) Int. Cl. G06F 19/00; G01C 25/00

(52) U.S. Cl. 702/92

(57) ABSTRACT

An azimuth computing device includes an azimuth computing unit for computing azimuth data by using an output from a magnetic sensor; a buffer unit for storing the azimuth data; a control unit for outputting azimuth data if the azimuth data stored in the buffer unit by a predetermined number of pieces is within a predetermined range; and a storage unit for storing the output azimuth data as a reference azimuth. The control unit outputs azimuth data if the azimuth data stored in the buffer unit is within a predetermined angle from the reference azimuth, and discards at least part of the azimuth data stored in the buffer unit if the azimuth data stored in the buffer unit is not within the predetermined range.

### CLAIM OF PRIORITY

This application is a Continuation of International Application No. PCT/JP2009/061492 filed on Jun. 24, 2009, which claims benefit of Japanese Patent Application No. 2008-177525 filed on Jul. 8, 2008. The entire contents of each application noted above are hereby incorporated by reference.

### BACKGROUND OF THE INVENTION

1. Field of the Invention

The present invention relates to an azimuth computing device, an azimuth computing method, an azimuth computing program, and an electronic device each computing an azimuth obtained by using an output from a magnetic sensor.

2. Description of the Related Art

A geomagnetic sensor is a device that calculates an azimuth based on a reference direction by using an output from a magnetic sensor. In recent years, a mobile terminal such as a mobile phone with the geomagnetic sensor is being developed. Japanese Unexamined Patent Application Publication No. 2005-291934 (hereinafter, referred to as document '934) discloses a mobile terminal capable of performing azimuth computation in an environment that likely causes a geomagnetic sensor to have a detection error. The document '934 discloses a method for correcting azimuth information if a detection value of the geomagnetic sensor becomes a predetermined abnormal state and if the predetermined abnormal state lasts for a predetermined time.

### SUMMARY OF THE INVENTION

There are various magnetic fields in the environment where the mobile terminal with the geomagnetic sensor is used. A magnetic field may be largely distorted, for example, in an area located near a railroad crossing or a pole (see reference sign X in FIG. 6). When a user with the mobile terminal walks straight toward a subject that causes the magnetic field to be distorted (or causes magnetostriction to occur) and passes by the subject, even if the magnetic field is being distorted, the magnetic field can become stable and is not shifted unless the user stops walking. Hence, with the method described in the document '934, when the user moves toward or away from the subject causing the magnetostriction, the azimuth that is calculated on the basis of geomagnetism containing the magnetostriction may be continuously output without being corrected. As the result, when azimuth computation is performed by using a detection value of the geomagnetic sensor, and display control for a display is performed by using the resulting azimuth direction, if the user approaches the subject causing the magnetostriction while the user walks straight, the display control may be performed in accordance with the result containing the magnetostriction (namely, the azimuth may be shifted).

In light of the situation, the present invention provides an azimuth computing device, an azimuth computing method, an azimuth computing program, and an electronic device each being capable of preventing an azimuth from being shifted until the azimuth becomes stable.

According to an aspect of the present invention, an azimuth computing device includes an azimuth computing unit for computing azimuth data by using an output from a magnetic sensor; a buffer unit for storing the azimuth data; a control unit for outputting azimuth data if the azimuth data stored in the buffer unit by a predetermined number of pieces is within a predetermined range; and a storage unit for storing the output azimuth data as a reference azimuth. The control unit outputs azimuth data if the azimuth data stored in the buffer unit is within a predetermined angle from the reference azimuth, and discards at least part of the azimuth data stored in the buffer unit if the azimuth data stored in the buffer unit is not within the predetermined range.

With this device, since azimuth entries are buffered during a predetermined period, even if an azimuth is shifted during the predetermined period, an azimuth before it is shifted can be continuously output, and the azimuth can be prevented from being shifted until the azimuth becomes stable. Accordingly, when azimuth computation is performed by using a detection value of the geomagnetic sensor and the display control for the display is performed in accordance with the resulting azimuth information, for example, if a user having the geomagnetic sensor moves straight and approaches the subject that causes the magnetostriction, the display control is prevented from being performed with the result containing the magnetostriction caused by the subject.

Also, with this device, only the angle from the reference azimuth can be calculated without making a judgment whether the respective azimuth data stored in the buffer unit is within the predetermined angle or not. Accordingly, a load of computation can be decreased.

In the azimuth computing device, if the azimuth data stored in the buffer unit is not within the predetermined range, the control unit may discard azimuth data not within a predetermined range with reference to azimuth data that has been stored last from among the azimuth data stored in the buffer unit.

With this device, azimuth data close to the azimuth data that has been stored last is retained, and the number of buffers that have to store data again is decreased. Accordingly, a new azimuth can be output fast at timing when a temporarily changed azimuth becomes stable.

In the azimuth computing device, if the azimuth data stored in the buffer unit is not within the predetermined range, the control unit may store in the storage unit azimuth data that has been stored last from among the azimuth data stored in the buffer unit, as a new reference azimuth.

With this device, a stable azimuth can be output faster than a case in which the reference azimuth is not updated.

According to another aspect of the present invention, an azimuth computing method includes the steps of computing azimuth data by using an output from a magnetic sensor; storing the azimuth data; outputting azimuth data if the azimuth data stored by a predetermined number of pieces is within a predetermined range; storing the output azimuth data as a reference azimuth; outputting azimuth data if the azimuth data is within a predetermined angle from the reference azimuth; and discarding at least part of the azimuth data if the azimuth data is not within the predetermined range.

With this method, only the angle from the reference azimuth can be calculated without making a judgment whether the respective azimuth data stored in the buffer unit is within the predetermined angle or not. Accordingly, a load of computation can be decreased.

In the azimuth computing method, if the azimuth data is not within the predetermined range, azimuth data not within a predetermined range with reference to azimuth data that has been stored last from among the azimuth data may be discarded.

With this method, azimuth data close to the azimuth data that has been stored last is retained, and the number of buffers that have to store data again is decreased. Accordingly, a new azimuth can be output fast at timing when a temporarily changed azimuth becomes stable.

In the azimuth computing method, if the azimuth data is not within the predetermined range, azimuth data that has been stored last from among the azimuth data may be stored as a new reference azimuth.

With this method, a stable azimuth can be output faster than a case in which the reference azimuth is not updated.

According to still another aspect of the present invention, provided is an azimuth computing program capable of being executed by a computer and outputs azimuth information by using an output from a magnetic sensor. The program includes the steps of buffering a reference azimuth entry in a buffer; buffering a newly obtained azimuth entry in a buffer; if azimuth entries are stored in all buffers and if differences in angle between all azimuth entries stored in the buffers and the reference azimuth are within a predetermined angle, outputting azimuth information; and if the azimuth entries are stored in all buffers and if a difference in angle between an azimuth entry stored in a buffer and the reference azimuth exceeds the predetermined angle, discarding all azimuth entries stored in the buffers and buffering the newly obtained azimuth in the buffer as a reference azimuth.

The azimuth computing program may further include the steps of if the azimuth entries are stored in all buffers and if a difference in angle between an azimuth entry stored in a buffer and the reference azimuth exceeds the predetermined angle, retaining an azimuth entry having a difference in angle within the predetermined angle with respect to the newly obtained azimuth from among the azimuth entries stored in the buffers; discarding the other azimuth entries; and buffering the newly obtained azimuth in the buffer as a reference azimuth.

With this program, since the azimuth entries are buffered during a predetermined period, even if an azimuth is shifted during the predetermined period, an azimuth before it is shifted is continuously output, and the azimuth can be prevented from being shifted until the azimuth becomes stable.

According to yet another aspect of the present invention, an electronic device includes a geomagnetic sensor including a plurality of magnetic sensors; and the above-mentioned azimuth computing unit for performing the azimuth computation by using the output from the geomagnetic sensor.

The electronic device may further include a display; and a display control unit for controlling an image on the display in accordance with azimuth information from the azimuth computing unit.

### BRIEF DESCRIPTION OF THE DRAWINGS

FIG. 1 is a block diagram briefly showing a configuration of an electronic device with a geomagnetic sensor according to an embodiment of the present invention;

FIG. 2 is a flowchart for explaining steps of an azimuth computing program according to an embodiment of the present invention;

FIG. 3A illustrates a state of azimuth entries (azimuth information) stored in buffers;

FIG. 3B illustrates a state of azimuth entries stored in the buffers;

FIG. 3C illustrates a state of azimuth entries stored in the buffers;

FIG. 3D illustrates a state of azimuth entries stored in the buffers;

FIG. 4A illustrates the relationship between the output value and the time in an environment with magnetostriction;

FIG. 4B illustrates a change in output from a geomagnetic sensor without the azimuth computing program according to the embodiment of the present invention;

FIG. 4C illustrates a change in output from the geomagnetic sensor with the azimuth computing program according to the embodiment of the present invention;

FIG. 5A illustrates the relationship between the output value and the time in the environment with magnetostriction;

FIG. 5B illustrates a change in output from the geomagnetic sensor without the azimuth computing program according to the embodiment of the present invention;

FIG. 5C illustrates a change in output from the geomagnetic sensor with the azimuth computing program according to the embodiment of the present invention; and

FIG. 6 is an illustration for explaining a subject that causes magnetostriction

### D DESCRIPTION OF THE PREFERRED EMBODIMENTS

Embodiments of the present invention will be described in detail below with reference to the accompanying drawings.

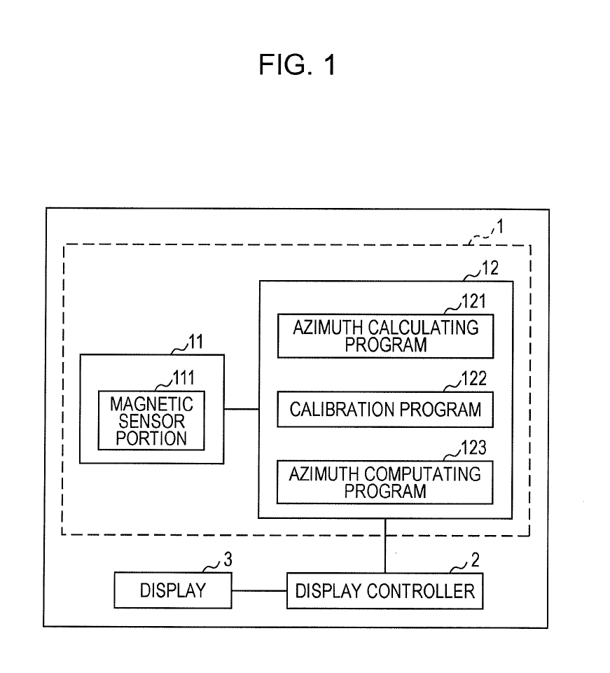

FIG. 1 is a block diagram briefly showing a configuration of an electronic device with a geomagnetic sensor according to an embodiment of the present invention. The electronic device shown in FIG. 1 mainly includes a geomagnetic sensor 1 according to this embodiment of the present invention, a display controller 2 that performs display control in accordance with azimuth information obtained by the geomagnetic sensor 1, and a display 3 that displays an image controlled by the display controller 2.

The geomagnetic sensor 1 mainly includes a geomagnetic sensor unit 11 and a control unit 12. The geomagnetic sensor unit 11 includes a geomagnetic sensor portion 111 having an X-axis magnetic sensor, a Y-axis magnetic sensor, and a Z-axis magnetic sensor. The control unit 12 includes an azimuth calculating program 121 that obtains an azimuth by using an output from the magnetic sensor portion 111, a calibration program 122 that obtains a reference point for outputs of the magnetic sensors by using the output from the magnetic sensor portion 111, and an azimuth computing program 123 that performs filtering for the azimuth information obtained by the azimuth calculating program 121.

The magnetic sensors included in the magnetic sensor portion 111 of the geomagnetic sensor unit 11 correspond to at least three axes for magnetic detection. The type of a sensor element for each of the magnetic sensors is not particularly limited. For example, the sensor element may be a magnetoresistive element, such as a giant magnetoresistive (GMR) element, an anisotropic magnetoresistive (AMR) element, a tunnel magnetoresistive (TMR) element, or a granular in gap (GIG) element; or other magnetic detector element, such as a hole element or an MI element. The geomagnetic sensor unit 11 also includes a processor that applies a voltage and a magnetic field to the magnetic sensor portion 111, and a processor that converts analog signals from the magnetic sensor portion 111 into digital signals.

The control unit 12 includes at least the azimuth calculating program 121, the calibration program 122, and the azimuth computing program 123, as driver software for driving the geomagnetic sensor unit 11. The azimuth calculating program 121 is a program that obtains an azimuth by using the outputs of the X-axis, Y-axis, and Z-axis magnetic sensors. The method for obtaining an azimuth is not particularly limited. The calibration program 122 is a program that obtains a reference point for the outputs of the X-axis, Y-axis, and Z-axis magnetic sensors. The method for obtaining a reference point is not particularly limited.

The azimuth computing program 123 is capable of being executed by a computer. The program 123 performs filtering for the azimuth information obtained by using the outputs of the magnetic sensors. The program 123 includes the steps of buffering a reference azimuth entry in a buffer; buffering an azimuth entry of a newly obtained azimuth if a difference in angle between the azimuth entry and the reference azimuth is within a predetermined angle with respect to the reference azimuth; and outputting azimuth information if azimuth entries are stored in all buffers.

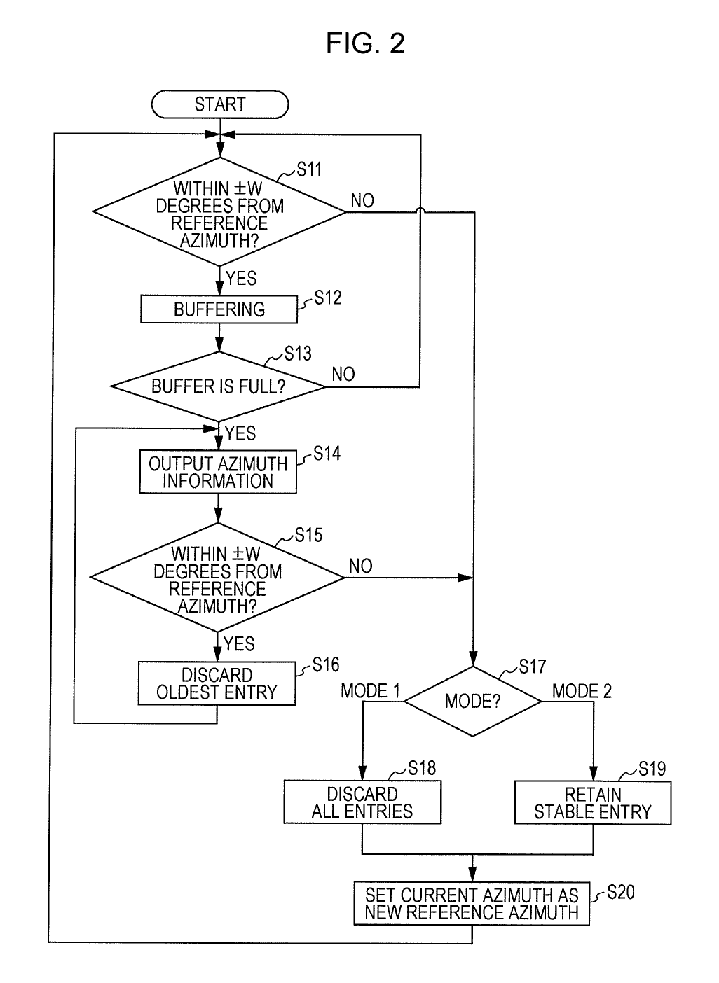

FIG. 2 is a flowchart for illustrating steps of the azimuth computing program according to an embodiment of the present invention.

First, parameters for the azimuth computation are designated. The parameters may include an azimuth stable width (for example, 0 to ±90°), an azimuth stabilization period (the number of sensor outputs), and a buffering mode if a value is not within the azimuth stable width. The azimuth stable width and the azimuth stabilization period may be appropriately set with regard to response of an azimuth output and stability of azimuth information. For example, to make the azimuth stability high, the azimuth stabilization period is increased, and to make the response of the azimuth output fast, the azimuth stabilization period is decreased.

Application or non-application of the azimuth computation may be determined by user's setting. For example, if the user sets the number of sensor outputs during the azimuth stabilization period to “0,” the azimuth computation is not applied. To simplify the explanation, it is assumed that azimuth stable width W=10, and azimuth stabilization period (the number of sensor outputs) N=8.

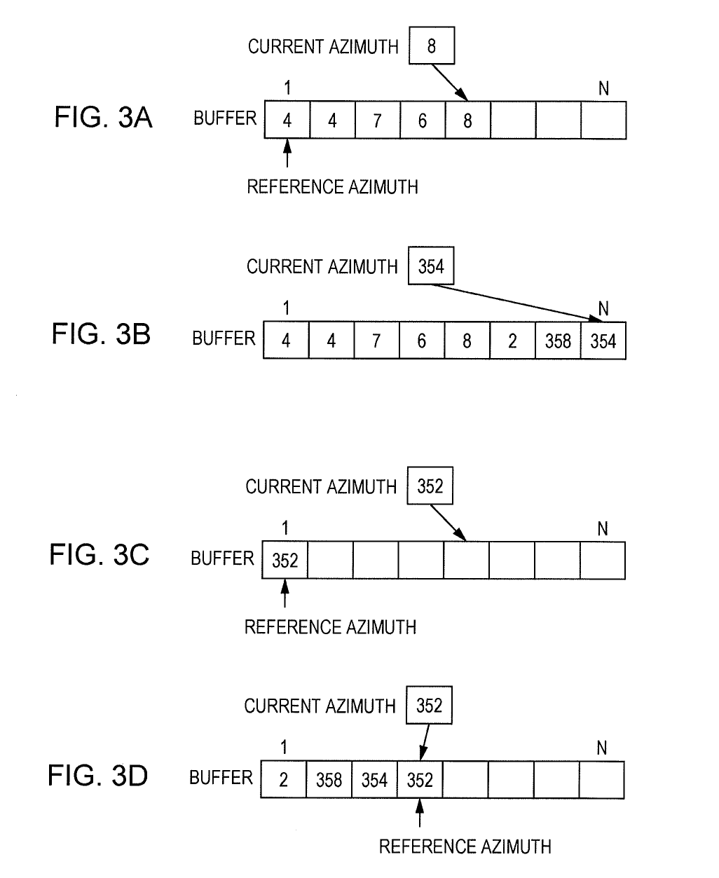

FIGS. 3A to 3D illustrate states of azimuth entries (azimuth information) stored in buffers. Azimuth entries are stored in buffers in order from a buffer 1 to a buffer N (in this case, to a buffer 8). The azimuth entry that is buffered first serves as a reference azimuth. Referring to FIG. 3A, “4” stored first in the buffer 1 serves as the reference azimuth. In a stable state, in particular, if azimuth entries buffered in all buffers are within the azimuth stable width from the reference azimuth, the azimuth entry continuously serves as the reference azimuth even when a new azimuth entry is stored in a buffer and an old azimuth entry is discarded. The azimuth entries are obtained by allocating azimuths that are calculated by the azimuth calculating program 121 into numbers from 1 to 360. Buffering is performed, for example, when an azimuth is calculated by the azimuth calculating program 121 and output from the sensor.

It is judged whether or not an azimuth (current azimuth) calculated by the azimuth calculating program 121 is within the azimuth stable width ±W (±10) from the reference azimuth (S11). If the current azimuth is within ±10 from the reference azimuth, the azimuth is buffered in a buffer as an azimuth entry (S12). Referring to FIG. 3A, values “4,” “7,” “6,” and “8” are within ±10 from the reference azimuth “4,” and hence the values are buffered in the buffers as azimuth entries. Buffering azimuth entries is continued until the buffers become full (i.e., until azimuth entries are stored in all buffers) (S13). Referring to FIG. 3B, values “2,” “358,” and “354” are within ±10 from the reference azimuth “4,” and hence the values are buffered in the buffers as azimuth entries. Thus, azimuth data is output if the azimuth data stored in the buffers is within a predetermined angle from a reference azimuth. Only the angle from the reference azimuth can be calculated without making a judgment whether the respective azimuth data stored in the buffers is within the predetermined angle or not. Accordingly, a load of computation can be decreased.

Referring to FIG. 3B, if the buffers are full and all azimuth entries are within ±10 from the reference azimuth “4,” it is expected that the azimuth is stable, and consequently azimuth information is output (S14). In FIG. 3B, the latest azimuth entry “354” is output as the azimuth information. The azimuth information is used for the display control of an image by the display controller 2. The display 3 displays the image after the display control.

When the buffers become full, it is judged whether or not the azimuth (current azimuth) calculated by the azimuth calculating program 121 is within the azimuth stable width ±10 from the reference azimuth (S15). If the azimuth is within ±10 from the reference azimuth, the azimuth is buffered in a buffer as an azimuth entry, and the oldest azimuth entry is discarded (S16). Even in this case, the value “4” continuously serves as the reference azimuth. In contrast, if the azimuth exceeds the azimuth stable width ±10 from the reference azimuth, the buffered azimuth entry is discarded and a new azimuth entry is assigned to the reference azimuth.

Discarding a buffered azimuth entry and assigning a new azimuth entry to a reference azimuth may be performed by two methods. A method (mode 1) includes discarding all azimuth entries stored in buffers and buffering a newly obtained azimuth in a buffer as a reference azimuth. With this method, azimuth data close to the azimuth data that has been stored last is retained, and the number of buffers that have to store data again is decreased. Accordingly, a new azimuth can be output fast at timing when a temporarily changed azimuth becomes stable. Another method (mode 2) includes retaining an azimuth entry if a difference in angle between the azimuth entry and a newly obtained azimuth entry is within a predetermined angle, discarding the other azimuth entry, and buffering the newly obtained azimuth in a buffer as a reference azimuth. With this method, a stable azimuth can be output faster than a case in which the reference azimuth is not updated.

Therefore, if the azimuth exceeds the azimuth stable width ±10 from the reference azimuth, it is judged whether the mode is the mode 1 or 2 (S17). If the mode is the mode 1, referring to FIG. 3C, all azimuth entries stored in the buffers are discarded (S18), and a current azimuth (“352”) is buffered in a buffer as a reference azimuth (S20). In contrast, if the mode is the mode 2, referring to FIG. 3D, azimuth entries (“2,” “358,” and “354”) are retained if differences in angle between the azimuth entries and a newly obtained azimuth (current azimuth) are within a predetermined angle (herein, ±10) (S19), the other entries are discarded, and the current azimuth (“352”) is buffered in a buffer as a reference azimuth (S20). This processing is also performed before the buffers become full if azimuth entries exceed the azimuth stable width ±10 from the reference azimuth.

The steps performed by the azimuth computing program may be performed by hardware. In particular, an azimuth computing device may be provided, the device including an azimuth computing unit for computing azimuth data by using an output from a magnetic sensor, a buffer unit for storing the azimuth data, and a control unit for outputting azimuth data if the azimuth data stored in the buffer unit by a predetermined number of pieces is within a predetermined range.

In this case, the azimuth computing device may include a storage unit for storing the output azimuth data as a reference azimuth. The control unit may output azimuth data if the azimuth data stored in the buffer unit is within a predetermined angle from the reference azimuth. The storage unit may be part of the buffer unit.

If the azimuth data stored in the buffer unit is not within the predetermined range, the control unit may discard at least part of the azimuth data stored in the buffer unit, or the control unit may discard azimuth data not within a predetermined range with reference to azimuth data that has been stored last from among the azimuth data stored in the buffer unit. If the azimuth data stored in the buffer unit is not within the predetermined range, the control unit may store in the storage unit azimuth data that has been stored last from among the azimuth data stored in the buffer unit, as a new reference azimuth.

Next, an example that was performed to clarify advantages of the present invention will be described.

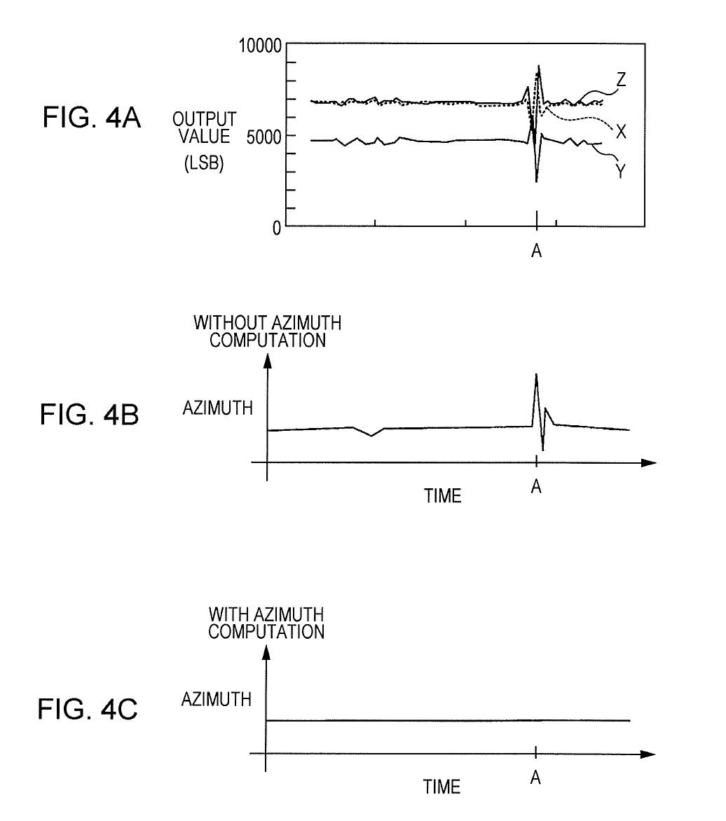

A geomagnetic sensor including the azimuth computing program according to the embodiment of the present invention and a geomagnetic sensor not including the azimuth computing program according to the embodiment of the present invention were mounted on a vehicle, and azimuth calculation was performed with the geomagnetic sensors while the vehicle moved straight toward a railroad crossing and passed through the railroad crossing. FIG. 4A illustrates the relationship between the time and the output value in this case. As shown in FIG. 4A, when the vehicle passed through the railroad crossing at a time A, the output value was largely changed due to magnetostriction caused by the railroad crossing. In this environment, with the geomagnetic sensor not including the azimuth computing program according to the embodiment of the present invention, the azimuth is largely shifted at the time A as shown in FIG. 4B although the vehicle moved straight and passed through the railroad crossing. In contrast, with the geomagnetic sensor including the azimuth computing program according to the embodiment of the present invention, the azimuth is not changed at the time A as shown in FIG. 4C. This is because azimuth entries are buffered during a predetermined period and hence even if an azimuth is shifted during the predetermined period, an azimuth before it is shifted can be continuously output.

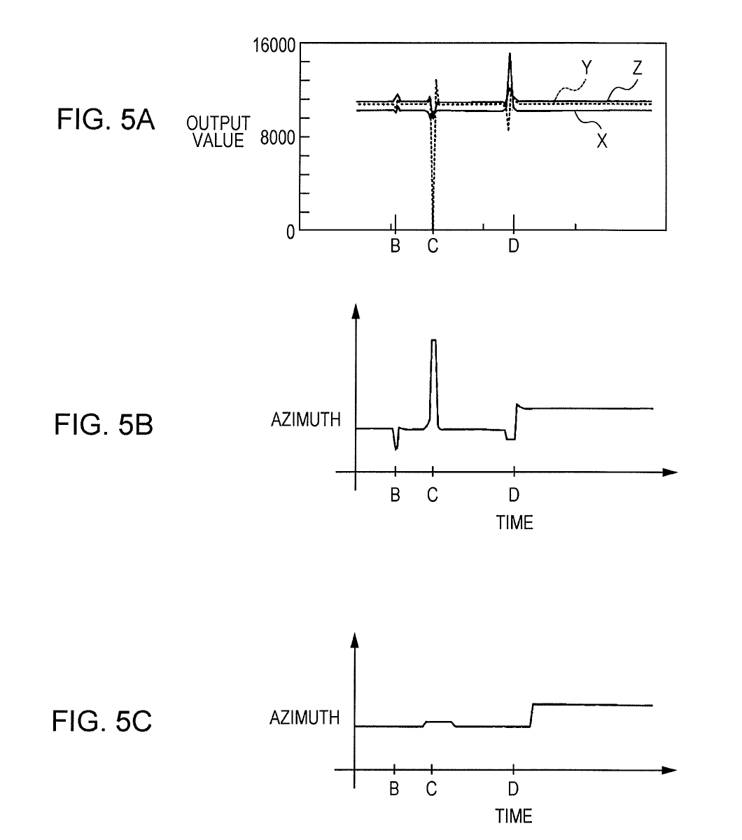

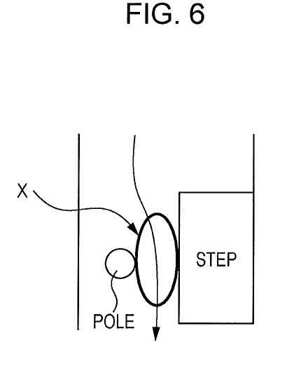

Also, changes in output were studied when a magnet was brought close to the geomagnetic sensor including the azimuth calculating program according to the embodiment of the present invention and when a magnet was brought close to the geomagnetic sensor not including the azimuth calculating program according to the embodiment of the present invention. FIG. 5A illustrates the relationship between the time and the output value in this case. Referring to FIG. 5A, the magnet was brought close to each geomagnetic sensor such that a distance between the magnet and the sensor is 100 mm at a time B and such that a distance between the magnet and the sensor is 10 mm at a time C, and the geomagnetic sensor was rotated at a time D.

In this environment, with the geomagnetic sensor not including the azimuth computing program according to the embodiment of the present invention, the azimuth was slightly shifted at the time B, was largely shifted at the time C, and followed the rotation at the time D and was changed as shown in FIG. 5B. In contrast, with the geomagnetic sensor including the azimuth computing program according to the embodiment of the present invention, the azimuth was not changed at the time B or the time C, and was changed at the time D without following the rotation as shown in FIG. 5C. This is because azimuth entries are buffered during a predetermined period and hence even if an azimuth is shifted during the predetermined period, an azimuth before it is shifted can be continuously output.

As described above, with the azimuth computing program according to the embodiment of the present invention, since azimuth entries are buffered during a predetermined period, even if an azimuth is shifted during the predetermined period, an azimuth before it is shifted can be continuously output, and hence the azimuth can be prevented from being shifted until the azimuth becomes stable. Accordingly, if the azimuth computation is performed by using the detection value of the geomagnetic sensor and the display control is performed in accordance with the resulting azimuth information, when the vehicle moves straight toward a subject causing magnetostriction and approaches the subject, the display control is not performed with the result containing magnetostriction.

The present invention is not limited to the above-described embodiment and may be appropriately modified in various ways upon implementation. For example, in the above-described embodiment, the three-axis geomagnetic sensor including the X-axis, Y-axis, and Z-axis magnetic sensors is used; however, the present invention may use a geomagnetic sensor corresponding to two or more axes. Also, in the above-described embodiment, the geomagnetic sensor unit and the control unit are separately arranged; however, in the present invention, the geomagnetic sensor unit may be integrally arranged with the control unit. The other configurations can be also appropriately modified within the scope of the present invention.

The azimuth computing device and the azimuth computing method according to the present invention can be applied to a mobile device such as a mobile phone, and an electronic device.

1. An azimuth computing device comprising:
an azimuth computing unit that computes azimuth data by using an output from a magnetic sensor;
a buffer that stores the azimuth data;
a control unit that outputs azimuth data if the azimuth data stored in the buffer unit by a predetermined number of pieces is within a predetermined range; and
a storage unit that stores the output azimuth data as a reference azimuth,
wherein the control unit outputs azimuth data if the azimuth data stored in the buffer is within a predetermined angle from the reference azimuth, and discards at least part of the azimuth data stored in the buffer if the azimuth data stored in the buffer is not within the predetermined range.

2. The azimuth computing device according to claim 1, wherein, if the azimuth data stored in the buffer is not within the predetermined range, the control unit discards azimuth data not within a predetermined range with reference to azimuth data that has been stored last from among the azimuth data stored in the buffer.

3. The azimuth computing device according to claim 1, wherein, if the azimuth data stored in the buffer is not within the predetermined range, the control unit stores in the storage unit azimuth data that has been stored last from among the azimuth data stored in the buffer, as a new reference azimuth.

4. An azimuth computing method comprising the steps of:
computing azimuth data by using an output from a magnetic sensor;
storing the azimuth data;
outputting azimuth data if the azimuth data stored by a predetermined number of pieces is within a predetermined range;
storing the output azimuth data as a reference azimuth;
outputting azimuth data if the azimuth data is within a predetermined angle from the reference azimuth; and
discarding at least part of the azimuth data if the azimuth data is not within the predetermined range.

5. The azimuth computing method according to claim 4, wherein, if the azimuth data is not within the predetermined range, azimuth data not within a predetermined range with reference to azimuth data that has been stored last from among the azimuth data is discarded.

6. The azimuth computing method according to claim 4, wherein, if the azimuth data is not within the predetermined range, azimuth data that has been stored last from among the azimuth data is stored as a new reference azimuth.

7. An azimuth computing program capable of being executed by a computer and outputs azimuth information by using an output from a magnetic sensor, the program comprising the steps of:
buffering a reference azimuth entry in a buffer;
buffering a newly obtained azimuth entry in a buffer;
if azimuth entries are stored in all buffers and if differences in angle between all azimuth entries stored in the buffers and the reference azimuth are within a predetermined angle, outputting azimuth information; and
if the azimuth entries are stored in all buffers and if a difference in angle between an azimuth entry stored in a buffer and the reference azimuth exceeds the predetermined angle, discarding all azimuth entries stored in the buffers and buffering the newly obtained azimuth in the buffer as a reference azimuth.

8. The azimuth computing program according to claim 7, further comprising the steps of:
if the azimuth entries are stored in all buffers and if a difference in angle between an azimuth entry stored in a buffer and the reference azimuth exceeds the predetermined angle, retaining an azimuth entry having a difference in angle within the predetermined angle with respect to the newly obtained azimuth from among the azimuth entries stored in the buffers;
discarding the other azimuth entries; and
buffering the newly obtained azimuth in the buffer as a reference azimuth.

9. An electronic device comprising:
a geomagnetic sensor including a plurality of magnetic sensors; and
the azimuth computing means according to claim 1 for performing the azimuth computation by using the output from the geomagnetic sensor.

10. The electronic device according to claim 9, further comprising:
a display; and
display control means for controlling an image on the display in accordance with azimuth information from the azimuth computing means.
